(19) United States
(12) Patent Application Publication
(10) Pub. No.: US 2017/0148047 A1
(43) Pub. Date: May 25, 2017

(54) Online Coupon Exchange Network

(71) Applicant: Jack Desenvolvimento de Sistemas Ltda, Rio de Janeiro (BR)

(72) Inventors: Fabio Augusto Marques Seixas, Rio de Janeiro (BR); Rafael Dantas Ruiz, Rio de Janeiro (BR)

(73) Assignee: Jack Desenvolvimento de Sistemas Ltda

(21) Appl. No.: 15/360,929

(22) Filed: Nov. 23, 2016

Related U.S. Application Data
(60) Provisional application No. 62/259,888, filed on Nov. 25, 2015.

(51) Int. Cl. G06Q 30/02; G06Q 30/08; G06Q 30/06

(52) U.S. Cl. CPC G06Q 30/0239; G06Q 30/0601; G06Q 30/08

(57) ABSTRACT

A method for distributing coupons through a network and online coupon distribution network, including the steps of: (a) storing offers and coupon codes from sellers on a coupon distribution server; (b) installing and configuring a web widget in a first seller's ecommerce store server; (c) displaying on the web widget at a shopper's terminal, offers or coupon codes from one or more other sellers in the coupon exchange network; (d) allowing a shopper to select or request one or more of the displayed offers or coupon codes; (e) sending from the coupon distribution server, the coupon code associated with the selected offer to the shopper terminal; and (f) recording transaction information about the shopper and selected offer. The invention also provides for the ranking of sellers in the network to control the display of the seller's offers and coupons.

This application claims priority from U.S. patent application No. 62/259,888, filed Nov. 25, 2015.

### FIELD OF INVENTION

The present invention relates to an online coupon distribution and exchange network and more particularly, to a method for performing online coupon distribution in an online coupon distribution and exchange system.

### BACKGROUND

In general commerce, retail stores or service providers (hereinafter, “sellers”) issue and distribute paid and/or free coupons as payment means, discount means or exchange means for goods or services. Coupons are distributed with certain conditions, such as a discount rate, a validity term, and the like. Shopper can purchase goods at a discounted price or obtain gifts by using the coupons.

In the electronic commerce over the internet, it is very common to sellers offer promotional coupon codes to potential buyers and shoppers with the intent of acquiring new customers and generating more sales. These coupon codes are distributed to shoppers by a variety of ways as such informative popups presented to visitors of their web sites and virtual stores, advertising and affiliate networks, direct messages by email or SMS and even through physical media such as flyers and print catalogs.

However, the way sellers distribute coupons to shoppers are limited to (a) offering coupons to their already known user base, such as shoppers that already bought from them or users who have registered on their web site or online store, and (b) through paid media such as online ad networks and affiliate networks with objective of reaching consumers hitherto unknown to the seller.

Furthermore, shoppers must directly visit online or offline coupon providers in order to obtain a variety of coupons. When the shopper does not have information on coupon providers, however, they cannot obtain such coupons. Coupons from non-reliable providers may not guarantee the right to purchase goods or services at a discount, and may give shoppers a bad experience.

As used herein, the term “web widget” refers to a widely known programing technique using computer code to incorporate the content of a first web site dynamically into a second web site.

### SUMMARY OF THE INVENTION

It is therefore an object of the present invention to provide a coupon distribution method in which, using a coupon distribution system based on web widgets, sellers participate in a coupon exchange network.

According to the present invention, there is provided a coupon exchange network and an online coupon distribution method, which includes: (a) registering offers and coupon codes from sellers in the coupon distribution server; (b) installing and configuring a web widget in a first seller's ecommerce store server; (c) displaying at a shopper's terminal, a web widget with offers or coupon codes from one or more other sellers in the coupon exchange network; (d) allowing a shopper to select or request, through the shopper's terminal, a specific one or more of the displayed offers or coupon codes; (e) sending from the coupon distribution server, the coupon code associated with the selected offer to the shopper terminal; and (f) sending information about the shopper to seller whose offer had been selected. Additional features of the invention include: (1) attributing credit units to a seller at the coupon distribution server; (2) adding and subtracting credit units from a seller in the coupon distribution server, based upon shopper transactions; and (3) providing for offer placement in other sellers' web sites, either directly or using a bidding method.

### BRIEF DESCRIPTION OF THE DRAWINGS

FIG. 1 is a block diagram of a coupon distribution system according to the present invention.

FIG. 2 is a flowchart illustrating sequential processes of a coupon distribution method according to the present invention.

FIG. 3 is a flowchart illustrating sequential processes of an optional credit and debit operation at the coupon distribution server according to the present invention

### DETAILED DESCRIPTION OF THE PREFERRED EMBODIMENT

The invention preferably consists of a server containing information about sellers, products offered by sellers and coupons for such products.

Hereinafter, preferred embodiments of the present invention will be described in detail with reference to the accompanying drawings so that they can be readily implemented by those skilled in the art.

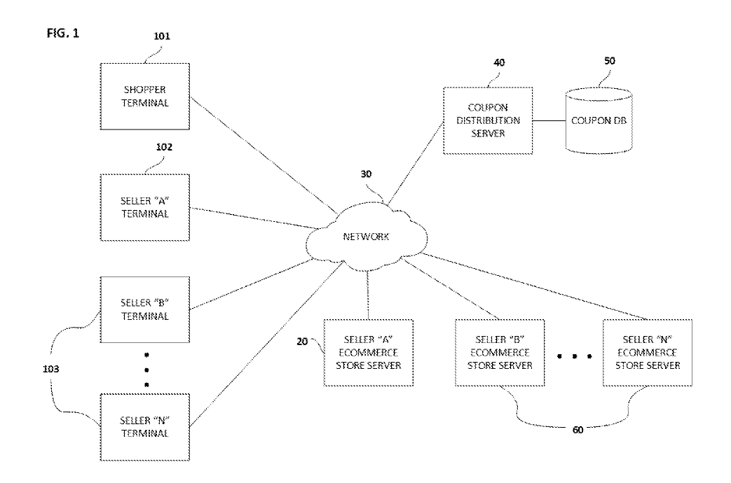

Referring to FIG. 1, the coupon distribution system includes a communication network 30, a shopper terminal 101, a first seller terminal 102, a first seller ecommerce store server 20, a coupon distribution server 40, and a coupon database 50.

The communication network 30 may be any type of data communication network, such as a local area network (LAN), a wide area network (WAN), the Internet, and the like. For example, the communication network 10 may include a wireless network such as a mobile communication network or a satellite communication network, as well as a wired network such as a private network or a public switched telephone network (PSTN).

The invention includes a shopper terminal 101, a first seller terminal 102 (seller “A”), an additional seller terminals 103 (sellers “B” through “N”). Examples of these terminals 101, 102, and 103 include computers, mobile phones, and personal digital assistants (PDAs) that can connect to the Internet through wired and/or wireless communication, and private terminals for connection to the coupon distribution server. The terminals 101, 102, and 103 include software programs such as a web browser for connection to a network 30. Terminal 101 provides a shopper with access to the sellers' ecommerce store servers 20 and 60 through the network 30. Terminals 102 and 103 provide sellers with access to the coupon distribution server 40 through the network 30.

After initial registration with the coupon distribution server 40, each seller receives a widget for installation on the seller's ecommerce store server 20 and 60. The widget is preferably computer code or a computer program that will be displayed by the ecommerce store server on the shopper's terminal 101. The widget receives data from the coupon distribution server 40.

The seller “A” ecommerce store server 20 is a computer connected to a network 30 used by a seller to sell products and/or services through the network 30 to shoppers. The sellers “B” through “N” ecommerce store servers 60 represent the ecommerce store servers of other sellers participating in the coupon exchange network. The ecommerce store servers 20 and 60 include the server or servers that many retail stores such as Amazon and GAP uses to sell products and services to shoppers.

The coupon distribution server 40 receives coupon-related information, e.g., a coupon code, a coupon sales price, a coupon use price at a goods store, use limitations such as a validity term, coupon benefits and the like from the seller terminals 102 and 103. The coupon distribution server 40 may register coupon information input by at least one seller, and apply specific criteria to the coupon offer. The criteria may include a type of benefit dependent on goods with coupons, a seller, a validity term, expiration date, purchase restrictions and the like.

The coupon distribution server 40 may provide a menu for enabling a seller to select one of a plurality of registered-coupon sales methods, including fixed price sales, percentage discount sales, auction, and joint purchase. For reference, the seller may select one sales method through one menu or command before, after, or when registering coupons.

The widget is preferably displayed when a shopper is ready to complete a purchase (a “checkout”), but may also be displayed to the shopper at any other time that the shopper is accessing the seller's ecommerce store server 20.

The widget presents a display on the shopper's terminal 101, presenting one or more offers and coupons from sellers in the network, which offers and coupons have been registered with the coupon distribution server by the sellers. The coupon distribution server 40 delivers the coupon and offer information to shoppers at the shopper's terminal 101, and displays the information on the terminal 101 having a connection to the coupon distribution server 40.

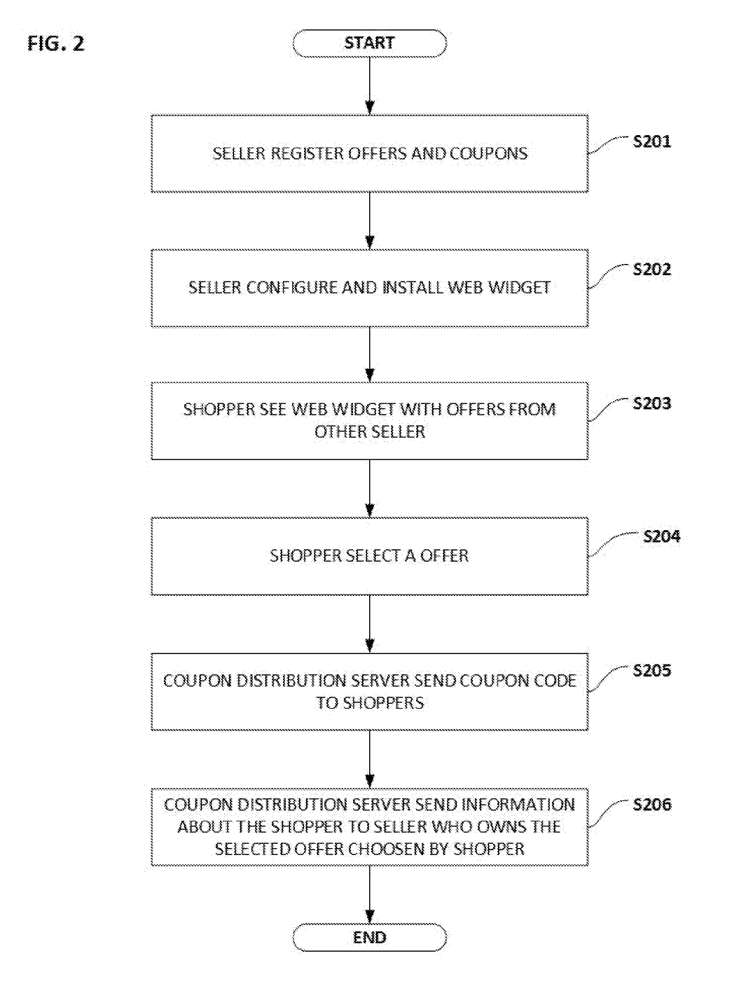

FIG. 2 is a flowchart illustrating a coupon distribution method.

First, each seller utilizes the seller terminal 102 or 103 to connect to the coupon distribution server 40 to register coupons or other offers in the coupon distribution server 40 (S201). The coupon distribution server 40 may provide a menu or other input screen to enable the seller to register the coupons or other offers. Alternatively, seller may upload a data file to coupon distribution server 40.

Specifically, the seller may connect to the coupon distribution server 40 using a connection program such as a web browser installed in his/her terminal 102 or 103 and may log in to the coupon distribution server 40 by inputting an ID and a password on an initial log-in window. After logging in, the seller may register the coupons by inputting coupon-related information on a specific screen window provided by the coupon distribution server 40 via the seller terminal 102 or 103.

In this case, each seller may register the coupons according to specific categories through a category-specific registration menu provided from the coupon distribution server 40. Specifically, the seller may call for, on the screen of the terminal, a specific screen window, provided by the coupon distribution server 40, for enabling coupons to be registered according to categories, select a specific one of categories including personal information such as a seller name or demographic, a discount period, gifts, and service type, and then input coupon-related information such as a code number, coupon sales price, a coupon use price at a goods store, a coupon issue form and format, use limitations such as a validity term, and coupon benefits. Once entered, the registered coupon-related information may be displayed on any terminal having a connection to the coupon distribution server 40.

The coupon distribution server 40 will generate computer code, namely a web widget, for each seller to install on the seller's ecommerce platform on the seller ecommerce store server 20 or 60 (S202). The seller may configure the web widget (S202) provided by the coupon distribution server 40. These configuration options include colors, texts, artwork and positioning of web page elements within the web widget.

After the seller “A” installs the web widget on seller's ecommerce store server 20, seller “A” ecommerce store server 20 will display the web widget to shoppers buying goods or services from seller “A” on the shopper terminal 101. The web widget connects to coupon distribution server 40 to exchange relevant shopper information and receive offers and coupons. The widget then displays offers and coupons from coupon distribution server 40. The offers and coupons displayed on the web widget are selected from offers and coupons registered by sellers (S201). In one embodiment of the present invention, the offers and coupons displayed through the web widget by the ecommerce store server of seller “A” are selected from offers and coupons registered by sellers “B” through “N” (S203). In an alternate embodiment, offers and coupons registered by seller “A” are also presented in the web widget.

The shopper can select one or more of the offers or coupons presented by clicking a button or other selection method as is well known in the art (S204).

Based upon the selection, coupon distribution server 40 will send the coupon code and other information to the shopper terminal 101 so they can use the coupon code at the ecommerce store server 60 of the seller “B” through “N” associated with the selected coupon (S205). In one embodiment of the invention, the web widget will redirect the shopper's terminal 101 to the ecommerce store server 60 of the selected seller.

The coupon distribution server 40 will send information about the shopper to the selected seller's ecommerce server, and will store the shopper's selection in database 50. (S206).

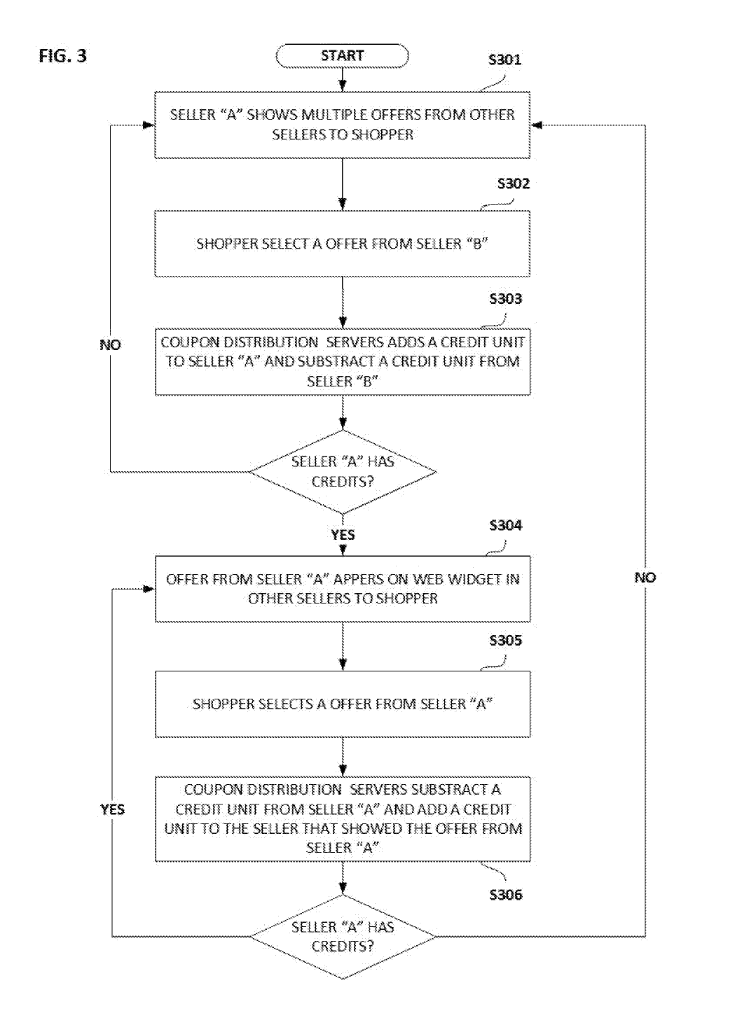

FIG. 3 is a flowchart illustrating a coupon exchange between sellers.

Seller “A” will display a web widget to shoppers through the shopper terminal 101 displaying coupons and offers from other sellers in the network (S301). If the shopper selects one or more of the offers (S302), e.g. an offer from Seller “B”, the selection information will be transmitted to coupon distribution server 40. Coupon distribution server will assign a credit to Seller “A” in the Seller “A” account at coupon distribution server 40 and Seller “B” will be assigned a debit or have a credit subtracted from the Seller “B” account at coupon distribution server 40 (S303).

In one embodiment of the invention, sellers may purchase or trade credit units in their account at coupon distribution server 40.

In one embodiment of the invention, the placement of a particular seller's coupons and offers in the web widget may be determined by the credit level in the seller's account at coupon distribution server 40, where a higher credit level will give a particular seller's coupons and offers a preferred placement over the coupons and offers of a seller with a lower credit level.

In a preferred embodiment of the invention, when a shopper is currently engaged with seller “A”, and seller “A” does not a positive credit unit balance, the coupons or offers of seller “A” will not be displayed to the shopper.

For example, where seller “A” has a positive credit units in its account, or if seller “A” is bidding money to have its offers displayed on the exchange network, the offers of seller “A” will appear in the web widget displayed to shoppers' terminals 101 from other sellers' ecommerce store servers 60. If seller “A” does not have positive credit units or has not paid to have its offers displayed on the exchange network, the web widget from seller “A” will continue to show offers from other sellers in his online store until some shopper selects an offer from another seller (S304), whereby seller “A” will receive a positive credit.

While visiting an online store from a seller in the network, when a shopper selects an offer from seller “A” (S305), seller “A” will have a credit unit subtracted from its account at coupon distribution server 40 (S306), or will otherwise be debited a bid amount that was offered to have an offer displayed in the widget.

While certain novel features of the present invention have been shown and described, it will be understood that various omissions, substitutions and changes in the forms and details of the device illustrated and in its operation can be made by those skilled in the art without departing from the spirit of the invention.

I claim:

1. An online coupon distribution method comprising:
registering a plurality of offers in a coupon distribution server, each offer associated with a seller and a coupon code;
installing and configuring a computer program on a first seller's ecommerce store server;
using the computer program to display, at a shopper terminal while the shopper's terminal is interacting with the first seller's ecommerce store server, a plurality of offers from the coupon distribution server;
selecting, at the shopper terminal, one of the plurality of offers;
transmitting to the shopper terminal a coupon code associated with the selected offer of the plurality of offers; and
transmitting information about the shopper to a second seller associated with the selected offer.

2. The online coupon distribution method of claim 1, further comprising:
selecting offers to be displayed at the shopper's terminal based on information retrieved from the first seller.

3. The online coupon distribution method of claim 1, further comprising:
establishing a plurality of seller accounts on the coupon distribution server, each seller account associated with a seller that has registered an offer and coupon code;
subtracting a credit unit from the seller account associated with the second seller; and
adding a credit unit to the seller account associated with the first seller.

4. The online coupon distribution method of claim 3, further comprising:
selecting offers to be displayed at the shopper's terminal based on an account status of seller accounts.

5. The online coupon distribution method of claim 3, further comprising:
allowing a seller to purchase credit units for its seller account on the coupon distribution server.

6. The online coupon distribution method of claim 3, further comprising:
allowing sellers to purchase offer placement in another seller's ecommerce store server using a bidding method.

7. A method of distributing coupon information, the method comprising:
receiving seller information from a plurality of sellers;
receiving coupon information from at least one of the plurality of sellers;
distributing a computer program to at least one of the plurality of sellers;
receiving transaction information from at least one of the plurality of sellers through the computer program;
identifying a relevant coupon based upon the transaction information;
generating a tracking coupon comprised of the relevant coupon and a tracking identifier;
transmitting the tracking coupon to the computer program; and
receiving tracking information from the tracking coupon.

8. The method of distributing coupon information of claim 7, further comprising:
maintaining a seller account for at least one of the plurality of sellers; and
applying a credit or debit to the seller account based upon the tracking information.

9. The method of distributing coupon information of claim 8, further comprising:
applying a ranking to at least one of the plurality of sellers;
determining the relevance of a coupon based upon the ranking of the at least one of the plurality of sellers; and
modifying the ranking based upon a status of the seller account.

10. A coupon distribution system comprising:
a database of seller information;
a database of coupon information;
transmission means for receiving seller and coupon information from a seller;
storage means for storing seller information into the seller information database;
transmission means for sending coupon information to a shopper; and
receiving means for receiving offer selection information from the shopper.

11. The coupon distribution coupon system of claim 10, further comprising:
applying a ranking to the seller; and
selecting coupon information to be transmitted to the shopper based upon the seller's ranking.
